(19) United States
(12) Patent Application Publication
(10) Pub. No.: US 2011/0223472 A1
(43) Pub. Date: Sep. 15, 2011

(54) CYLINDRICAL BATTERY CELL WITH NON-AQUEOUS ELECTROLYTE

(76) Inventors: Kohtaro Ikeda, Mito-shi (JP); Hideki Shinohara, Hitachiota-shi (JP); Akira Unno, Hitachinaka-shi (JP)

(21) Appl. No.: 13/029,406

(22) Filed: Feb. 17, 2011

(30) Foreign Application Priority Data
Mar. 9, 2010 (JP) 2010-052127

(51) Int. Cl. H01M 2/08; H01M 2/04

(52) U.S. Cl. 429/174

(57) ABSTRACT

A non-aqueous electrolyte battery cell according to the present invention includes: a generating unit; a battery cell container that contains the generating unit; and a sealing lid, disposed in an open end portion of the battery cell container, and that seals the battery cell container via an insulating gasket; wherein a sealing point of the insulating gasket is established at a region that is spaced by a predetermined distance in radially outward direction of the cylindrical battery cell from an inner peripheral edge of a folded over portion that is formed at the open end portion of the cylindrical battery cell container.

### INCORPORATION BY REFERENCE

The disclosure of the following priority application is herein incorporated by reference: Japanese Patent Application No. 2010-052127, filed Mar. 9, 2010.

### BACKGROUND OF THE INVENTION

1. Field of the Invention

The present invention relates to a sealed insulating construction for a cylindrical battery cell that includes a non-aqueous electrolyte.

2. Description of Related Art

While, in the prior art, aqueous electrolyte type secondary battery cells such as lead-acid battery cells and nickel-cadmium battery cells and so on have been widely used as secondary battery cells, the energy density has been low, because, with these aqueous electrolyte type secondary battery cells, an operating voltage does not exceed the electrolytic potential of

Due to demand, not only for compact battery cells of around 1.5 Ah capacity for consumer use but also for large sized battery cells for electrical power storage or electric automobiles, that has appeared in recent years along with requirements for energy saving and environmental preservation, research and development have proceeded apace into battery cells that employ a non-aqueous electrolyte, of which lithium secondary battery cells are representative. Such a non-aqueous electrolyte battery cell has high operating voltage and high energy density, and its cycling characteristics are also excellent.

However, with such a non-aqueous electrolyte battery cell, it is necessary scrupulously to prevent penetration of moisture into the battery cell and also to prevent escape of the electrolyte component into the atmosphere, and ensuring of the sealing performance becomes even more important than in the case of an aqueous electrolyte type secondary battery cell.

While, as sealing methods for ensuring the sealing performance of a non-aqueous electrolyte battery cell, the method of sealing a sealing lid into an opening portion of the battery cell container by laser welding, and a method of tightly sealing the battery cell with a sealing lid by swaging the sealing lid into the opening portion of the battery cell container while interposing between them a gasket made from insulating resin (refer to, for example, Japanese Patent 4,223,134) have principally been employed, the latter method is more generally used with a non-aqueous electrolyte battery cell.

### SUMMARY OF THE INVENTION

With the non-aqueous electrolyte cylindrical battery cell of Japanese Patent 4,223,134, it is necessary reliably to prevent leakage of the electrolytic fluid by increasing the adherence between the insulating resin gasket and the battery cell container and the sealing lid. The region where the gasket and the sealing lid is most closely adhered, and therefore the gasket is most compressed becomes the critical sealing region that determines the sealing performance of the battery cell, and this critical sealing region is defined at the inner edge of the folded around portion of the open end portion of the battery cell container.

Since the open end portion of the battery cell container is folded around and further bent in the direction towards the bottom portion of the battery cell container, accordingly the folded around internal peripheral edge constituted by this end portion is the critical sealing point. However in the region of this internal peripheral edge, a scratch is easily formed due to abrasion during the process of swaging this internal periphery, and in this case there is a possibility of subsequent oxidization corrosion of this scratched portion due to the environment in which the battery cell is used, for example due to high humidity or the like, so that there is a fear that the sealing performance will break down.

According to the 1st aspect of the present invention, a cylindrical battery cell containing a non-aqueous electrolyte comprises: a generating unit; a battery cell container that contains the generating unit; and a sealing lid, disposed in an open end portion of the battery cell container, and that seals the battery cell container via an insulating gasket; wherein a sealing point of the insulating gasket is established at a region that is spaced by a predetermined distance in radially outward direction of the cylindrical battery cell from an inner peripheral edge of a folded over portion that is formed at the open end portion of the cylindrical battery cell container.

According to the 2nd aspect of the present invention, a cylindrical battery cell containing a non-aqueous electrolyte comprises: a generating unit; a battery cell container that contains the generating unit; and a sealing lid, disposed in an open end portion of the battery cell container, and that seals the battery cell container via an insulating gasket; wherein the sealing lid is fixed by swaging at the open end portion of the battery cell container so that upper and lower surfaces of its peripheral portion are sandwiched by the insulating gasket, and so that sealing points are established upon the insulating gasket where it contacts the upper and lower surfaces of the peripheral portion of the sealing lid.

According to the 3rd aspect of the present invention, in a cylindrical battery cell containing a non-aqueous electrolyte according to the 2nd aspect, it is preferred that the respective thickness dimensions Ha and Hb of the insulating gasket at the sealing points at the upper and lower surfaces of the peripheral portion after processing satisfy Ha>Hb.

According to the 4th aspect of the present invention, in a cylindrical battery cell containing a non-aqueous electrolyte according to the 2nd aspect, it is preferred that an annular swaged space is defined at the open end portion of the battery cell container; and the upper and lower surfaces of the peripheral portion of the sealing lid are sandwiched within a inner surface of the annular swaged space, with the interposition of the insulating gasket.

According to the 5th aspect of the present invention, in a cylindrical battery cell containing a non-aqueous electrolyte according to the 4th aspect, it is preferred that the annular swaged space is a space that is sandwiched between a protruding portion that is formed by concaving inwards the outer peripheral surface of the open end portion of the battery cell container, and a folded over portion that is formed by folding over the open end portion of the battery cell container towards interior of the battery cell, and the folded over portion is formed as a sloping surface that is parallel to a plane orthogonal to the axis of the battery cell, or whose angle of inclination downwards towards an axis of the battery cell is less than 5°.

According to the 6th aspect of the present invention, in a cylindrical battery cell containing a non-aqueous electrolyte according to the 1st or 2nd aspect, it is preferred that the insulating gasket is made from a perfluorocarbon type fluororesin.

According to the present invention, it is possible to enhance the performance of the battery cell container for sealing.

### BRIEF DESCRIPTION OF THE DRAWINGS

FIG. 1 is a vertical sectional view showing an embodiment of the non-aqueous electrolyte cylindrical battery cell according to the present invention;

FIG. 2 is an exploded perspective view of the sealed type battery cell shown in FIG. 1;

FIG. 3 is a perspective view for showing the details of an electrode group of FIG. 1, and shows a state in which one portion has been cut away;

FIG. 4 is a partial sectional view showing a swaged construction at a peripheral portion of a sealing lid of the non-aqueous electrolyte cylindrical battery cell of FIG. 1;

FIG. 5 is a vertical sectional view showing a first step in the processing of the annular portion shown in section in FIG. 4;

FIG. 6 is a vertical sectional view showing a second step in the processing of the annular portion shown in section in FIG. 4;

FIG. 7 is a vertical sectional view showing a third step in the processing of the annular portion shown in section in FIG. 4;

FIG. 8 is a vertical sectional view showing a fourth step in the processing of the annular portion shown in section in FIG. 4; and

FIG. 9 is a table in which the benefits of this embodiment are detailed.

### DESCRIPTION OF THE PREFERRED EMBODIMENT

In the following, an embodiment in which the sealed type battery cell of the present invention is applied to a cylindrical lithium ion secondary battery cell will be explained with reference to the drawings.

Construction of the Sealed Type Battery Cell

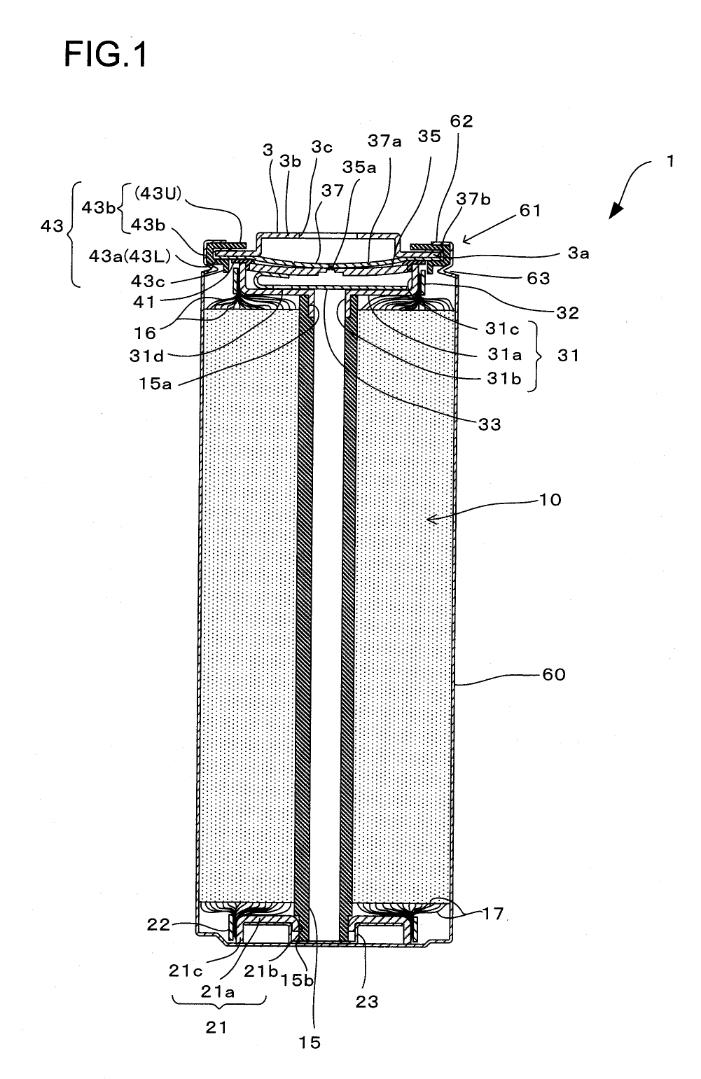

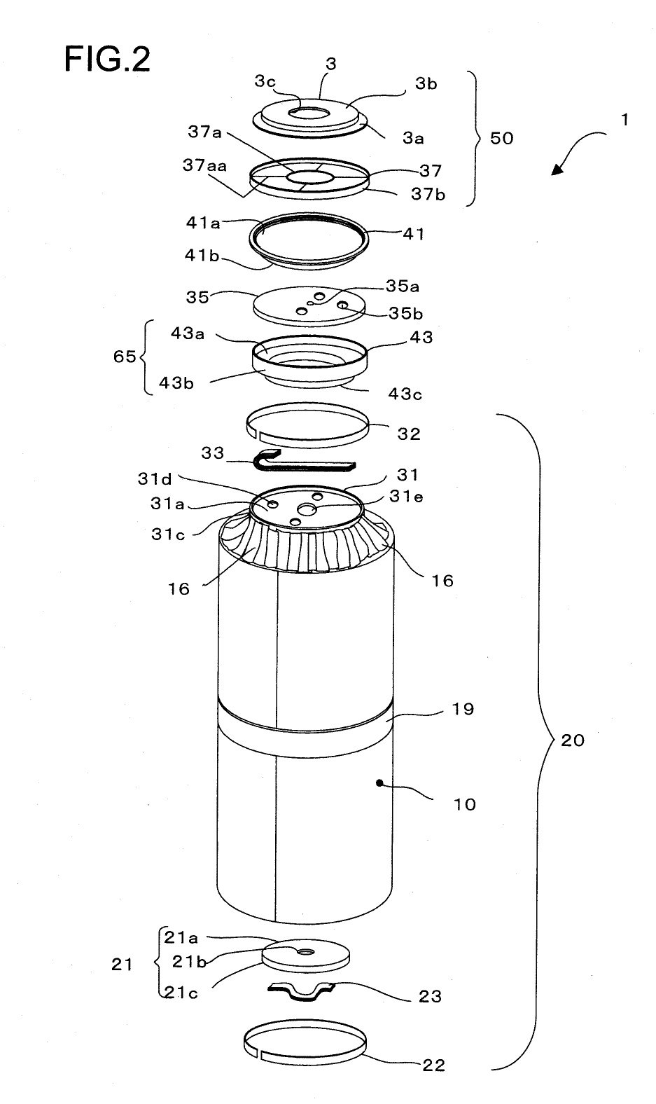

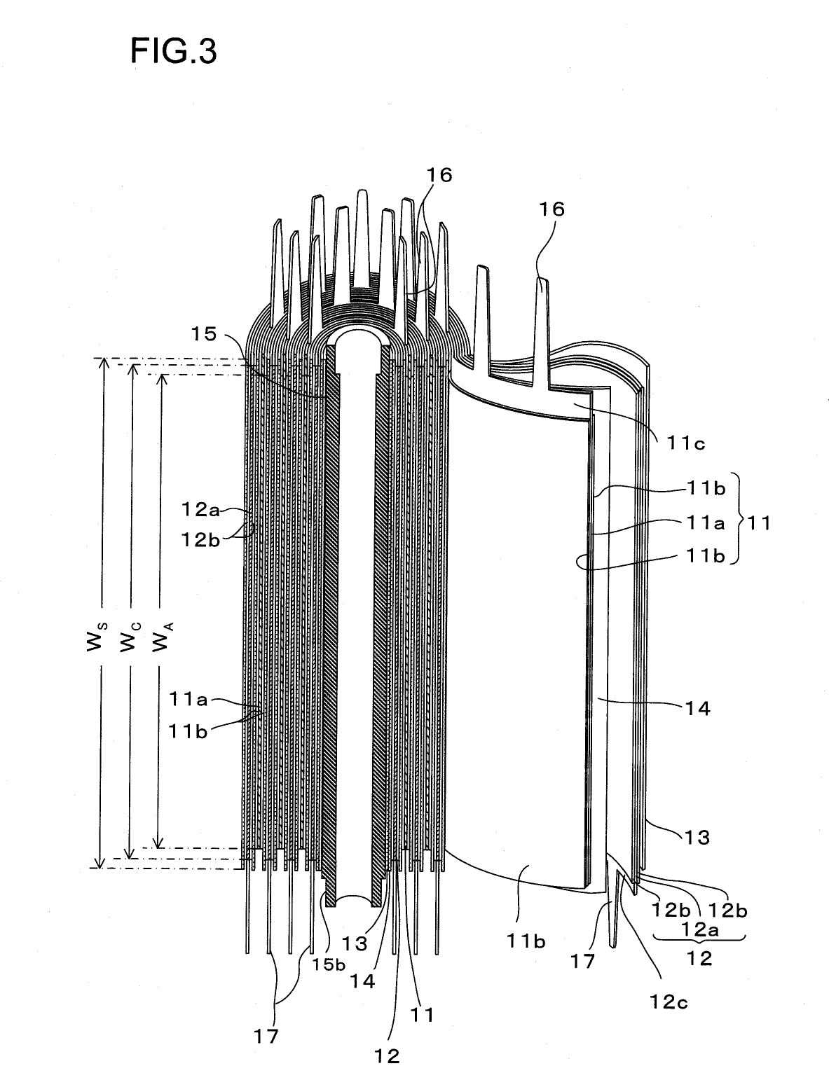

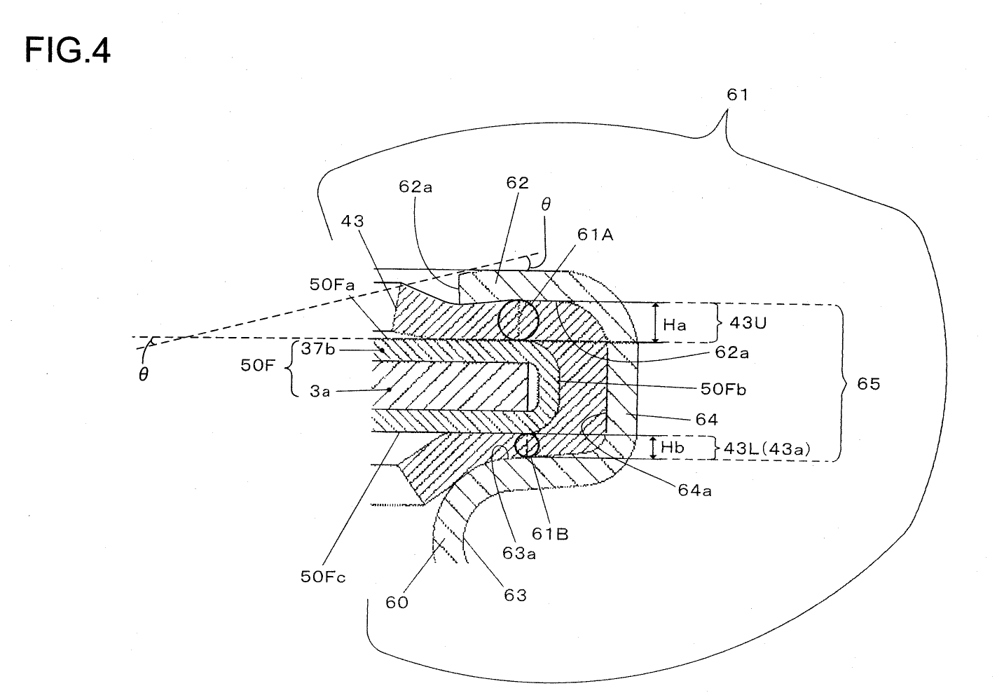

FIG. 1 is a vertical sectional view showing this embodiment of the sealed type non-aqueous electrolyte cylindrical battery cell of the present invention, and FIG. 2 is an exploded perspective view of the sealed type battery cell shown in FIG. 1. Moreover, FIG. 3 is a figure for explanation of a generating unit shown in FIG. 3, and FIG. 4 is a figure that shows the details of a sealing lid swaged construction.

This sealed type battery cell 1 may be shaped as a cylinder that has an external shape of, for example, diameter 40 mm and height 100 mm. The cylindrical secondary battery cell 1 includes a battery cell container 60 that is cylindrical and has a bottom and that contains a generating unit 20, and whose opening portion is closed with a sealing lid 50. In the following, first, the battery cell container and the generating unit 20 will be explained, and next the sealing lid 50 will be explained.

The Battery Cell Container 60

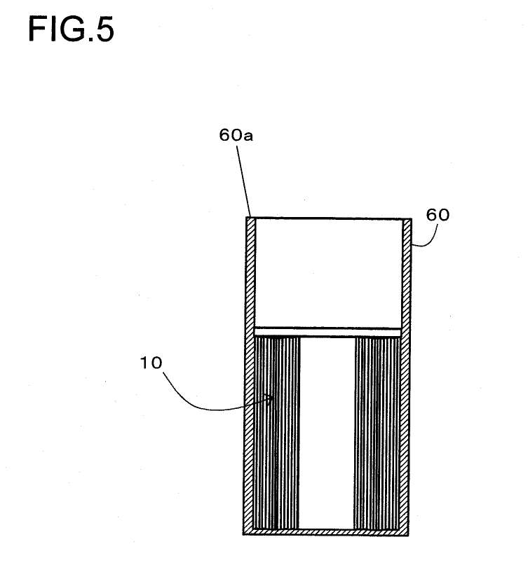

This cylindrical battery cell container 60 with a bottom has a swaged portion 60 formed at its open end portion 60a (refer to FIG. 5). The sealing performance of this sealed type battery cell 1 that employs a non-aqueous electrolyte is assured by the sealing lid 50 being fixed by swaging to the battery cell container 60 at this swaged portion 61. The swaged portion 61 includes a folded over portion 62 where the open end portion 60a is folded over radially inwards, and a protruding portion 63 that protrudes radially inward at a position spaced by a predetermined axial distance towards the bottom surface of the battery cell from its open end portion 60a. As will be described hereinafter, the sealing lid 50 is fixed by swaging between the folded over portion 62 and the protruding portion 63, with the interposition of a gasket 43 between them, and thereby the battery cell is sealed.

The Generating Unit 20

As will be explained below, the generating unit 20 is made as an integral unit that includes an electrode group 10, a positive electrode current collecting member 31, and a negative electrode current collecting member 21. The electrode group 10 has a winding core 15 at its central portion, and a positive electrode, a negative electrode, and separators are wound around this winding core. FIG. 3 shows the detailed construction of the electrode group 10, and is a perspective view showing the electrode group 10 in a state with a portion thereof cut away. As shown in FIG. 3, this electrode group 10 has a structure in which a positive electrode 11, a negative electrode 12, and first and second separators 13 and 14 are wound around the outside of the winding core 15.

In this electrode group 10, at its innermost, a first separator 13 is wound around and contacts the outer circumferential surface of the winding core 15, and then, outside this first separator 13, a negative electrode 12, a second separator 14, and a positive electrode 11 are laminated in that order, and are wound up. And, inside the innermost winding of the negative electrode 12, the first separator 13 and the second separator 14 are wound a certain number of times (in FIG. 3, once). Furthermore, the negative electrode 12 appears on the outside, with the first separator 13 being wound around it. And, on the outside, the first separator 13 is held together with adhesive tape 19 (refer to FIG. 2).

The positive electrode 11 is made from aluminum foil and has an elongated shape, and includes a positive electrode sheet 11a and a processed positive electrode portion in which a positive electrode mixture is applied to form a layer 11b on both sides of this positive electrode sheet 11a. The upper side edge of the positive electrode sheet 11a along the longitudinal direction, to both sides of which the positive electrode mixture is not applied and along that the aluminum foil is accordingly exposed, constitutes a positive electrode mixture untreated portion 11c that is not treated with the positive electrode mixture. A large number of positive leads 16 are formed integrally at regular intervals upon this positive electrode mixture untreated portion 11c, and project upwards parallel to the winding core 15.

The positive electrode mixture consists of an active positive electrode material, an electrically conductive positive electrode material, and a positive electrode binder. The active positive electrode material is desirably a lithium metal oxide or a lithium transitional metal oxide. For example, lithium cobalt oxide, lithium manganate, lithium nickel oxide, or a compound lithium metal oxide (that includes two or more sorts of lithium metal oxides selected from the lithium metal oxides based on cobalt, nickel, and manganese) may be suggested. The electrically conductive positive electrode material is not particularly limited, provided that it is a substance that can assist transmission to the positive electrode of electrons that are generated in the positive electrode mixture by a lithium occlusion/emission reaction. As examples of a material for this electrically conductive positive electrode mixture, graphite or acetylene black or the like may be suggested. It should be noted that the above mentioned compound lithium metal oxide including transitional metal components may also be used as a conductive positive electrode material, since it has a conductivity.

The positive electrode binder holds together the active positive electrode material and the electrically conductive positive electrode material, and also is capable of adhering together the layer of positive electrode mixture 11b and the positive electrode sheet 11a, and is not particularly limited, provide that it is not greatly deteriorated by contact with the non-aqueous electrolyte. As an example of a material for this positive electrode binder, polyvinylidene fluoride (PVDF) or fluorine-containing rubber or the like may be suggested. The method of making the positive electrode mixture layer 11b is not particularly limited, provided that it is a method of forming the layer of positive electrode mixture upon the positive electrode. As an example of a method for making a layer the positive electrode mixture 11b, the method may be suggested of applying, onto the positive electrode sheet 11a, a solution in which the substances that make up the positive electrode mixture are dispersed.

As a method for applying the positive electrode mixture to the positive electrode sheet 11a, a roll coating method, a slit die coating method or the like may be suggested. As a solvent for the solution in which the positive electrode mixture is to be dispersed, for example, it may be added to N-methylpyrrolidone (NMP) or water or the like and kneaded into a slurry, that is then applied uniformly to both sides of an aluminum foil of thickness, for example, 20 μm; and, after drying, this may be cut up by stamping. The positive electrode mixture may be applied, for example, to a thickness of around 40 μm on each side. When the positive electrode sheet 11a is cut out by stamping, the positive leads 16 are formed integrally therewith at the same time.

The negative electrode 12 is made from copper foil and has an elongated shape, and includes a negative electrode sheet 12a and a processed negative electrode portion in which a negative electrode mixture is applied to form a layer 12b on both sides of this negative electrode sheet 12a. Both sides of the lower side edge of the negative electrode sheet 12a along the longitudinal direction, to which the negative electrode mixture is not applied and along which the copper foil is accordingly exposed, constitute a negative electrode mixture untreated portion 12c that is not treated with the negative electrode mixture. A large number of negative leads 17 are formed integrally at regular intervals upon this negative electrode mixture untreated portion 12c, and project downwards in the direction opposite to that in which the positive leads 16 project.

The negative electrode mixture consists of an active negative electrode material, a negative electrode binder, and a thickener. This negative electrode mixture may also include an electrically conductive negative electrode material such as acetylene black or the like. It is desirable to use graphitic carbon as the active negative electrode material. By using graphitic carbon, it is possible to manufacture a lithium ion secondary battery cell that is suitable for a plug-in hybrid vehicle or electric vehicle, for which high capacity is demanded. The method for forming a layer of the negative electrode mixture 12b is not particularly limited, provided that it is a method that can form a layer of the negative electrode mixture 12b upon the negative electrode sheet 12a. As a method for applying the negative electrode mixture to the negative electrode sheet 12a, for example, the method may be suggested of applying upon the negative electrode sheet 12a a solution in which the constituent substances of the negative electrode mixture are dispersed. As the method for application, for example, a roll coating method, a slit die coating method or the like may be suggested.

As a method for applying the negative electrode mixture to the negative electrode sheet 12a, for example, N-methyl-2-pyrrolidone or water may be added to the negative electrode mixture as a dispersal solvent and kneaded into a slurry, that is then applied uniformly to both sides of a rolled copper foil of thickness, for example, 10 μm; and, after drying, this may be cut up by stamping. The negative electrode mixture may be applied, for example, to a thickness of around 40 μm on each side. When the negative electrode sheet 12a is cut out by stamping, the negative leads 17 are formed integrally therewith at the same time.

If the widths of the first separator 13 and of the second separator 14 are termed Ws, the width of the layer of negative electrode mixture 12b that is formed upon the negative electrode sheet 12a is termed W_{C}, and the width of the layer of positive electrode mixture 11b that is formed upon the positive electrode sheet 11 a is termed W_{A}, then the manufacturing process is performed so that the following equation is satisfied:

Ws>Wc>W_{A} (refer to FIG. 3)

In other words, the width W_{C} of the layer of negative electrode mixture 12b is always greater than the width W_{A} of the layer of positive electrode mixture 11b. This is done because, in the case of a lithium ion secondary battery cell, when the lithium that is the active positive electrode material is ionized and permeates the separator, if there is some portion on the negative electrode sheet 12a at which the layer of active negative electrode material 12b is not formed so that the negative electrode sheet 12a is exposed to the layer of active positive electrode material 11b, then the lithium therein will be deposited upon the negative electrode sheet 12a, and this can cause an internal short circuit to occur.

Referring to FIGS. 1 and 3, a stepped portion 15a with a diameter larger than the inner diameter of the winding core 15 is formed on the inner surface of the hollow cylindrical shaped winding core 15 at its upper end portion in the axial direction (the vertical direction in the drawing), and a positive electrode current collecting member 31 is pressed into this stepped portion 15a. This positive electrode current collecting member 31 may, for example, be made from aluminum, and includes a circular disk shaped base portion 31a, a lower top portion 31b that projects to face towards the winding core 15 at the surface of this base portion 31 a facing the electrode group 10 and that is pressed over the inner surface of the stepped portion 15a, and an upper cylinder portion 31c that projects out towards the sealing lid 50 at the peripheral edge portion of the outer circumferential portion of the base portion 31a. An aperture 31d is formed at the base portion 31a of the positive electrode current collecting member 31, for allowing the escape of gas generated in the interior of the battery cell. It should be noted that the winding core 15 is made of such a material that isolates electrically between the positive electrode current collecting member 31 and the negative electrode current collecting member 21, and that also keeps the axial rigidity of the battery cell. In the present embodiment, for example, as the material for the winding core 15, a glass-fiber reinforced polypropylene is employed.

All of the positive leads 16 of the positive electrode sheet 11 a are welded to the upper cylinder portion 31c of the positive electrode current collecting member 31. In this case, as shown in FIG. 2, the positive leads 16 are overlapped over one another and joined upon the upper cylinder portion 31 c of the positive electrode current collecting member 31. Since each of these positive leads 16 is very thin, accordingly it is not possible for a large electrical current to be taken out by just one of them. Due to this, the large number of positive leads 16 are formed at predetermined intervals over the total length of the upper edge of the positive electrode sheet 11a from the start of its winding onto the winding core 15 to the end of that winding.

The positive leads 16 of the positive electrode sheet 11a and an annular pressure member 32 are welded to the external periphery of the upper cylinder portion 31c of the positive electrode current collecting member 31. The large number of positive leads 16 are closely clamped against the external peripheral surface of the upper cylinder portion 31c of the positive electrode current collecting member 31, the pressure member 32 is wound over the externally oriented surfaces of the positive leads 16 and temporarily fixed there, and then they are all welded together in that state.

Since the positive electrode current collecting member 31 is oxidized by the electrolyte, its reliability can be enhanced by making it from aluminum. When the aluminum on the front surface is exposed by any type of processing, immediately a coating of aluminum oxide is formed upon that front surface, so that it is possible for oxidization by the electrolyte to be prevented due to this layer of aluminum oxide. Moreover, by making the positive electrode current collecting member 31 from aluminum, it becomes possible to weld the positive leads 16 of the positive electrode sheet 11 a thereto by ultrasonic welding or spot welding or the like.

A stepped portion 15b whose outer diameter is smaller than the outer diameter of the winding core 15 is formed upon the external peripheral surface of the lower end portion of the winding core 15, and a negative electrode current collecting member 21 is pressed over this stepped portion 15b and thereby fixed thereto. This negative electrode current collecting member 21 may, for example, be made from copper, and is formed with a circular disk shaped portion 21a and with an opening portion 21b that is formed in the disk shaped portion 21a and pressed over the stepped portion 15b of the winding core 15; and, on its outer peripheral edge, an external circumferential cylinder portion 21c is formed so as to project outwards in the bottom portion of the battery cell container 60.

All of the negative leads 17 of the negative electrode sheet 12a are welded to the external circumferential cylinder portion 21c of the negative electrode current collecting member 21 by ultrasonic welding or the like. Since each of these negative leads 17 is very thin, in order to take out a large electrical current, a large number of them are formed over total length of the lower edge of the negative electrode sheet 12a from the start of its winding onto the winding core 15 to the end of its winding, at predetermined intervals.

The negative leads 17 of the negative electrode sheet 12a and the annular pressure member 22 are welded to the external periphery of the external circumferential cylinder portion 21c of the negative electrode current collecting member 21. The large number of negative leads 17 are closely clamped against the external peripheral surface of the external circumferential cylinder portion 31c of the negative electrode current collecting member 21, the pressure member 22 is wound over the externally oriented surfaces of the negative leads 17 and temporarily fixed there, and then they are all welded together in that state.

A negative electrode power lead 23 that is made from copper is welded to the lower surface of the negative electrode current collecting member 21. This negative electrode power lead 23 is welded to the bottom portion of the battery cell container 60. The battery cell container 60 may, for example, be made from carbon steel of thickness 0.5 mm, and its surface is processed by nickel plating. By using this type of material, it is possible to weld the negative electrode power lead 23 to the battery cell container 60 by resistance welding or the like.

The one end portion of a flexible electrically conducting positive electrode lead 33 that is made by laminating together a plurality of layers of aluminum foil is joined to the upper surface of the base portion 31 a of the positive electrode current collecting member 31 by welding. Since this conducting positive electrode lead 33 is made by laminating together and integrating a plurality of layers of aluminum foil, accordingly it is capable of carrying a large electrical current, and moreover it is endowed with flexibility. In other words, while it is necessary to make the thickness of the connection member great in order for it to conduct a high electrical current, if it were to be made from a single metallic plate, its rigidity would become high, and it would lose its flexibility. Accordingly this connection member is made by laminating together a large number of sheets of aluminum foil of low thickness, thus preserving its flexibility. The thickness of the conducting positive electrode lead 33 may, for example, be 0.5 mm, and it may be made by laminating together 5 sheets of aluminum foil each of thickness 0.1 mm.

As explained above, by the large number of positive leads 16 being welded to the positive electrode current collecting member 31 and the large number of negative leads 17 being welded to the negative electrode current collecting member 21, the positive electrode current collecting member 31, the negative electrode current collecting member 21, and the electrode group 10 are integrated together into the generating unit 20 (refer to FIG. 2). However, in FIG. 2, for the convenience of illustration, the negative electrode current collecting member 21, the pressure member 22, and the negative electrode power lead 23 are shown as separated from the generating unit 20.

The Sealing Lid 50

The details of the sealing lid 50 will now be explained with reference to FIGS. 1, 2, and 4.

The sealing lid 50 is assembled in advance as a sub-assembly, and includes a cap 3 that has an opening 3c, a cap casing 37 installed upon the cap 3 and that has cleavage grooves 37a and 37aa, a positive electrode connection plate 35 that is spot welded to the central portion of the rear surface of the cap casing 37, and an insulating ring 41 that is sandwiched between the edge of the upper surface of the positive electrode connection plate 35 and the rear surface of the cap casing 37.

The cap 3 is made from a ferrous material such as carbon steel or the like, and is nickel plated. This cap 3 has the overall shape of a hat, and includes a peripheral portion 3a shaped as a circular disk (i.e. an annular portion) and a top portion 3b that projects upwards from this peripheral portion 3a. An opening portion 3c is formed in the center of the top portion 3b. This top portion 3b functions as an external positive terminal, for connection to a bus bar or the like (not shown).

The peripheral portion of the cap 3 is gripped by a folded round flange 37b of the cap casing 37, that is made from aluminum alloy. In other words, the cap 3 is fixed to the cap casing 37 by the border of the cap casing 37 being folded back around and along the upper surface of the edge of the cap 3 and then being swaged. This circular ring where the border of the cap casing 37 is folded back around the edge of the upper surface of the cap 3 is then friction stir welded, so as further to fix the flange 37b and the cap 3 together by friction stir welding. In other words, the cap casing 37 and the cap 3 are integrated together at the flange 37b both by swaging and by welding. By doing this, the sealing lid 50 is endowed with a flange 50F, defined at the portion where the flange 37b of the cap casing 37 and the annular portion 3a of the cap 3 are integrated together.

A ring shaped cleavage groove 37a and four cleavage grooves 37aa that extend radially in four directions from this circular cleavage groove 37a are formed upon the central circular region of the cap casing 37. These cleavage grooves 37a and 37aa are portions where the upper surface of the cap casing 37 has been squashed with an appropriate tool so as to form V-shaped grooves, and so that the portions that remain are quite thin. And, when the internal gas pressure within the battery cell container 60 rises to be above some standard value, these cleavage grooves 37a and 37aa rupture, so that the internal gas is vented.

The sealing lid 50 constitutes an anti-explosion mechanism. When, due to generation of gas in the interior of the battery cell container 60, its internal gas pressure rises to exceed the standard value, cracking of the cap casing 37 takes place at the cleavage grooves 37a and 37aa. Then the internal gas is vented through the opening 3c to the outside, so that the pressure within the battery cell container 60 is reduced. Furthermore, due to the internal pressure within the battery cell container 60, the cap casing 37 bulges towards the exterior, and its electrical connection with the positive electrode connection plate 35 is broken, so that any electrical current flow thereafter is blocked.

The sealing lid 50 is mounted above an upper cylinder portion 31c of the positive current collecting member 31, so as to be insulated therefrom. In other words, the cap casing 37 that is integrated with the cap 3 is mounted upon the upper end surface of the positive current collecting member 31 while in the state of being electrically insulated by the insulating ring 41. However, the cap casing 3 is electrically connected to the positive current collecting member 31 by a positive current conducting lead 33, so that the cap 3 of the sealing lid 50 constitutes the positive electrode for this battery cell 1. Now, the insulating ring 41 has an opening portion 41a (refer to FIG. 2) and a side portion 41b that projects downwards. The connection plate 35 is fitted into this opening portion 41a of the insulating ring 41.

The connection plate 35 is made from aluminum alloy, and is almost entirely uniform except for its central portion, but that central portion is sagged to a somewhat lower position, so that the connection plate 35 is substantially formed in a dish-shape. This connection plate 35 may, for example, be around 1 mm thick. A projecting portion 35a formed in the shape of a small dome is formed at the center of the connection plate 35, and a plurality of apertures 35b are formed around this central projecting portion 35a (refer to FIG. 2). These apertures 35b have the function of venting gas generated in the interior of the battery cell. The central projecting portion 35a of the connection plate 35 is joined to the central portion of the bottom surface of the cap casing 37 by resistance welding or friction diffusion welding.

And an electrode group 10 is contained within the battery cell container 60, with the sealing lid 50 that has been manufactured in advance as a partial assembly being mounted inside the cell container 60 on the protruding portion 63 of the cell container 60, and being electrically connected to the positive current collecting member 31 by the positive current conducting lead 33. And, by pressing or the like, an external peripheral wall portion 43b of the gasket 43 is subjected to swage processing and is folded around, so that the sealing lid 50 is pressed and squeezed in the axial direction by the base portion 43a and this external peripheral wall portion 43b. Due to this, the sealing lid 50 is fixed to the battery cell container 60 with the interposition of the gasket 43 between them.

Initially, as shown in FIG. 2, the gasket 43 has a shape that includes this external peripheral wall portion 43b that is formed to stand upwards almost vertically at the outer circumferential edge of the annular base portion 43, and a cylinder portion 43c that is formed so as to drop downwards almost vertically from the inner circumferential edge of the annular base portion 43a. The thickness of the wall portion 43b and the thickness of the base portion 43a are substantially same. And, by the swaging process for the battery cell container 60, the sealing lid 50 is sandwiched by the battery cell container 60 with the interposition of the deformed external peripheral wall portion 43b between them.

The point of greatest compression of the gasket 43 that seals most tightly between the sealing lid 50 and the battery cell container 60 becomes the critical point for sealing that determines the sealing performance for this battery cell. In the prior art, this critical sealing point was established as being at the edge of the folded over end portion at the open end portion 60a of the battery cell container 60, indeed at its very end edge where it was folded around and brought inwards a certain distance radially towards its interior. However, in the present invention, it is planned to improve the durability by establishing this critical sealing point as being at a position that is spaced away towards the external periphery of the battery cell, from that end edge of the end portion thereof that has been folded somewhat radially inwards. Furthermore, with the sealed type battery cell according to this embodiment of the present invention, it is planned to enhance the sealing performance by establishing critical sealing points between the gasket 43 and the battery cell container 60 at two separate locations.

The details of the swaged construction by which the sealing lid 50 is fixed by swaging to the open end portion 60a of the battery cell container 60 will be explained hereinafter.

A predetermined amount of a non-aqueous electrolyte is injected into the interior of the battery cell container 60. One substance that may desirably be used for this non-aqueous electrolyte is a lithium salt dissolved in a carbonate type solvent. Lithium hexafluorophosphate (LiPF6) or lithium hexafluoroborate (LiBF6) may be cited as examples of lithium salts. And ethylene carbonate (EC), dimethyl carbonate (DMC), propylene carbonate (PC), or methyl-ethyl carbonate (MEC), or mixtures of two or more solvents selected from the solvents described above, may be cited as examples of carbonate type solvents.

The Sealing Lid Swaged Construction

FIG. 4 is a figure showing the swaged construction by which the sealing lid 50 is fixed to the battery cell container 60, and is an enlarged vertical sectional view of the principal portions at the edge of the battery cell opening.

The swaged portion 61 is formed on the open end portion 60a of this cylindrical battery cell container 60 with a bottom (refer to FIG. 5). As described above, this swaged portion 61 includes the folded over portion 62 at which the open end portion 60a of the container 60 is folded over inwards, and the protruding portion 63 at which the outer wall of the container is protruded inwards at just a predetermined distance from the folded over portion 62 towards the bottom surface of the battery cell, and the folded over portion 62 and the protruding portion 63 are connected by a short axial portion 64 of the circumferential wall of the container (refer to FIG. 4). An annular swaged space 65 is thus defined by the lower surface 62a of the folded over portion 62, the circumferential wall 64 of the container, and the upper surface 63a of the protruding portion 63. This annular swaged space 65 is the space in which the sealing lid swage construction is installed.

In FIG. 4, the cross section of the right half of the annular swaged space 65 is generally defined as a horizontally lying U-shape with its bottom portion towards outside. The gasket 43 is provided around the inner circumferential surface of this swage space 65, so as to be squeezed by the flange 50F of the sealing lid 50. The flange 50F of the sealing lid 50 is made by integrating together the cap casing 37 and the cap 3.

The material for the insulating gasket 43 may, for example, be a perfluorocarbon type fluororesin. As will be described hereinafter, the reason for employing such a resin is in order to increase the rigidity of the gasket 43 somewhat, and in order to adjust the angle of inclination of the folded over portion to 0° to less than 5°. Accordingly, this material is not limited to being a perfluorocarbon type fluororesin, provided that it is a material which makes it possible to maintain the sealing performance.

The gasket 43 is interposed and compressed between the upper surface 50Fa of the flange 50F and the lower surface 62a of the folded over portion 62, between the outer peripheral surface 50Fb of the flange 50F and the inner peripheral surface 64a of the circumferential container wall 64, and between the lower surface 50Fc of the flange 50F and the upper surface 63a of the protruding portion 63. The gasket 43 between the upper surface 50Fa of the flange 50F and the lower surface 62a of the folded over portion 62, in other words the upper portion 43U (the upper portion of external peripheral wall portion 43b, refer to FIG. 2) of the gasket 43, is very much compressed at its region 61A. This region 61A is termed the first compression point (i.e., is a first critical sealing point). And the gasket 43 between the lower surface 50Fc of the flange 50F and the upper surface 63a of the protruding portion 63, in other words the lower portion 43L (base portion 43a, refer to FIG. 2) of the gasket 43, is very much compressed at its region 61B. This region 61B is termed the second compression point (i.e., is a second critical sealing point).

In this embodiment, the first and second compression points (i.e. the first and second critical sealing points) are established in this manner. Moreover, as shown in FIG. 4, the thickness Ha of the upper side of the upper-side 43U at the first compression point 61A of the gasket 43 is set to be greater than the thickness Hb of the lower side 43L at the second compression point 61B of the gasket 43. In other words, the compression ratio of the gasket 43L at its second compression point is set to be greater than the compression ratio of the gasket 43U at its first compression point. It should be noted that in FIG. 4 the cylinder portion 43c shown in FIGS. 1 and 2 is omitted.

While, in the prior art, the critical sealing point was established at the peripheral inner edge 62a of the folded over portion 62, in this embodiment, the first critical sealing point is established at the region 61A that is somewhat radially displaced towards the battery cell external periphery from this inner peripheral edge 62a of the folded over portion 62. With the first critical sealing point being established at this type of position, during the process of folding over the open end portion 60a of the battery cell container 60, it is arranged for the angle of inclination θ of the folded over portion 62 with respect to a plane orthogonal to the battery cell axis to become from 0° to less than 5°. Moreover, the position, the shape (i.e. curvature), and the dimensions of the protruding portion 63 are adjusted so that the compression ratio of the gasket portion 43L at the second compression point becomes greater than the compression ratio of the gasket portion 43U at the first compression point.

The sealed type battery cell according to the embodiment explained above is capable of providing the beneficial operational effects described below.

(1) A sealing point is established at the region 61A that is towards the external periphery of the battery cell from the inner peripheral edge 62a of the folded over portion 62. If the sealing point were to be established at the inner peripheral edge 62a of the folded over portion 62, then, if during the processing damage was caused to the inner peripheral folded over edge portion 62a, subsequently the sealing performance might deteriorate due to oxidization of the folded over inner peripheral edge 62a caused by the environmental conditions of use of the battery cell, for example by humidity. However, by establishing the sealing point somewhat towards the external periphery of the battery cell from the inner peripheral edge 62a of the folded over portion 62, i.e. somewhat towards the inner portion of the seal therefrom, thereby it is ensured that the inner peripheral edge 62a of the folded over portion 62 can exert no influence upon the sealing performance, and also there is no fear of leakage of the electrolyte.

(2) Since the two sealing points by the gasket 43 are established at two separate locations, i.e. at the region 61A and at the region 61B, accordingly the sealing performance is enhanced, as compared with the prior art case in which only one sealing point is established at only one location.

(3) The compression ratio of the gasket 43L at the region 61B is set to be higher than the compression ratio of the gasket 43U at the region 61A. In other words, the sealing performance of the gasket portion 43L that is positioned more inwardly towards the interior of the battery cell container is made to be higher. As a result, it is possible to prevent leakage of the electrolyte at a location more towards the interior of the battery cell.

(4) The material that is used for the insulating gasket 43 is a perfluorocarbon type fluororesin. Since the rigidity of this resin is high enough to control the angle of inclination θ of the folded over portion 62 within the range of 0° to 5°. Due to the rigidity of this fluororesin, together with setting this inclination angle θ from 0° to 5°, a highly compressed region, the first critical sealing point, is set in the region 61A. With a resin whose rigidity was low, the sealing point would be set at the internal circumferential edge 62a of the folded over portion 62. Accordingly, it would not be possible to improve the sealing performance. It should be noted that in the present embodiment, the above sealing point 61 A is moved outward from as the above inclination angle θ of the folded over portion 62 is decreased, and also as the rigidity of the gasket is increased. Therefore, the position of the sealing point 61A can be set at a desired position inside from (i.e. outwards from the center of the battery cell) the internal circumferential edge 62a of the folded over portion 62. And, when the sealing point is moved outward, the compression rate at the sealing point 61A is decreased. Thus, because the sealing performance becomes lower as the sealing point moves to outward, the sealing point 61A is set at a desired optimum position by adjusting the inclination angle θ of the folded over portion 62 and the rigidity of the gasket. It should be noted that the state in which the inclination angle θ of the folded over portion 62 is 0° corresponds to the state in which the folded over portion 62 is parallel to the upper surface 50Fa of the flange 50, i.e. the folded over portion 62 is parallel to a plane orthogonal to the axis of the battery cell

Next, the processing for swaging the sealing lid 50 to the battery cell container 60 (i.e. the sealing process) will be described.

### Process #1

First, as shown in FIG. 5, the electrode group 10 and so on is housed within the battery cell container 60, and an intermediate member is installed, welded to the bottom portion. It should be understood that, in FIGS. 5 through 8, the portions that are being processed are displayed in bold, and certain components are omitted as appropriate.

### Process #2

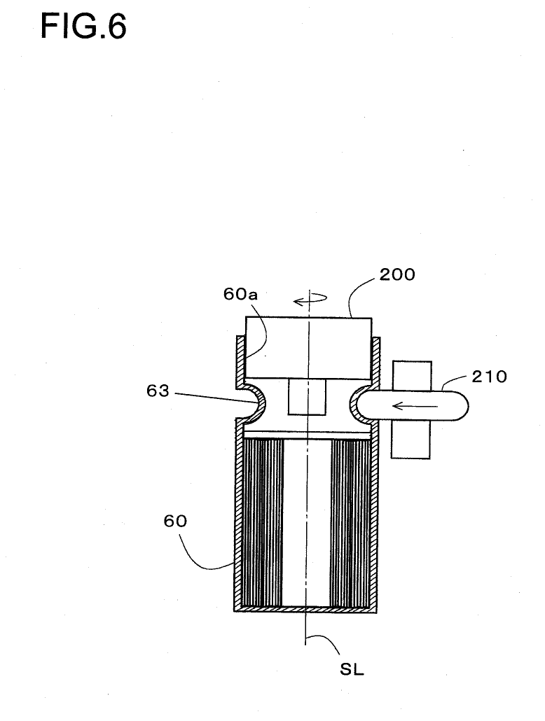

Next, as shown in FIG. 6, in the state in which a guide support member 200 is inserted into the battery cell container 60 from the opening of its aperture 60A, a roller 210 for forming a groove is pressed against the outer surface of the battery cell container 60 at a predetermined height, and the battery cell container 60 is rotated around its own axis SL, which is so-called a spinning process. Due to this, the battery cell container 60 is squeezed down towards its central axis by the roller 210, so that the protruding portion 63 is formed.

### Process #3

The gasket 43 is loaded into the battery cell container 60 above the protruding portion 63. In this state, the gasket 43 is in its unstressed configuration in which its external peripheral wall portion 43b projects vertically upwards from its annular base portion 43a, as shown in FIG. 2. In this state, the gasket 43 is received within the interior of the portion of the battery cell container 60 above its protruding portion 63.

And the sealing lid 50, that has been manufactured in advance as a partial assembly, is electrically connected to the positive current collecting member 31 by the positive current conducting lead 33, and the flange 50F of this sealing lid 50 is mounted upon the cylinder portion 43c of the gasket 43. At this time, it is arranged for the upper cylinder portion 31 c of the positive current collecting member 31 to be fitted over the external periphery of the flange 41b of the insulating ring 41.

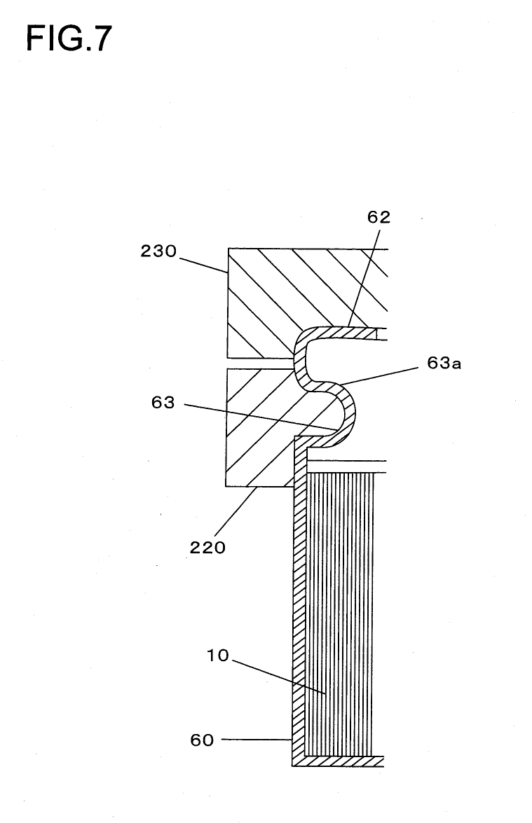

And in this state, as shown in FIG. 7, in the state in which the insulating gasket 43 and the sealing lid 50 are disposed upon the upper surface 63a of the annular protruding portion 63 (in the figure, these components are omitted), while the battery cell container 60 is held in a support die 220 that is split into, for example, three portions around its circumference and that acts as a chuck, the open end portion 60a is swaged inward from above by a swaging die 230. Due to this, the gasket 43 is compressed between the protruding portion 63 and the folded over portion 62 of the battery cell container 60, and due to this so-called swaging processing, the sealing lid 50 is fixed to the battery cell container 60 with the gasket 43 being interposed therebetween.

### Process #4

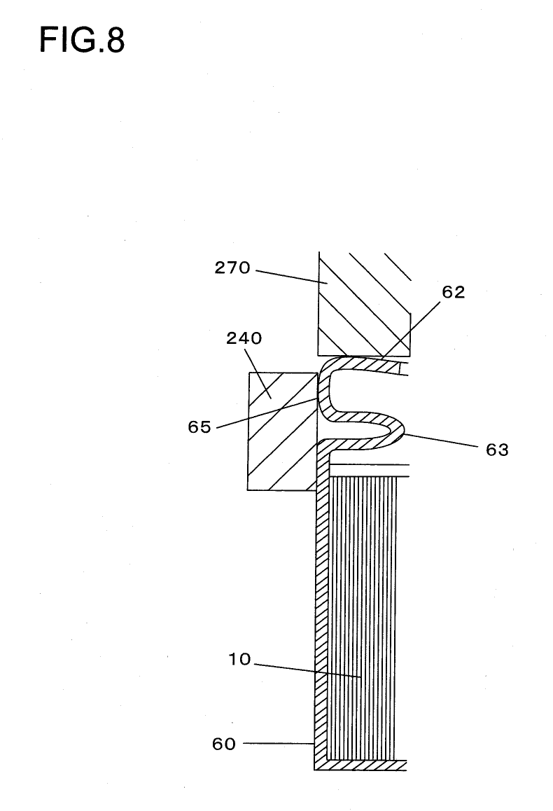

Finally, as shown in FIG. 8, while the external periphery of the battery cell container 60 is supported by a sizing die 240, the annular necked portion 63 is pressed from above with another sizing die 270, and thereby the folded over portion 62 and the necked portion 63 are crushed downwards so as to be clinched tightly together. Due to this, along with the height of the battery cell container 60 being adjusted to a predetermined dimension, also the crimped contact between the battery cell container 60 and the insulating gasket 43 is reliably assured.

The positive current collecting member 31 and the cap 3 are electrically connected together via the positive current conducting lead 33, the connection plate 35, and the cap casing 37, so that the manufacture of the cylindrical secondary battery cell shown in FIG. 1 is completed.

Results of Testing

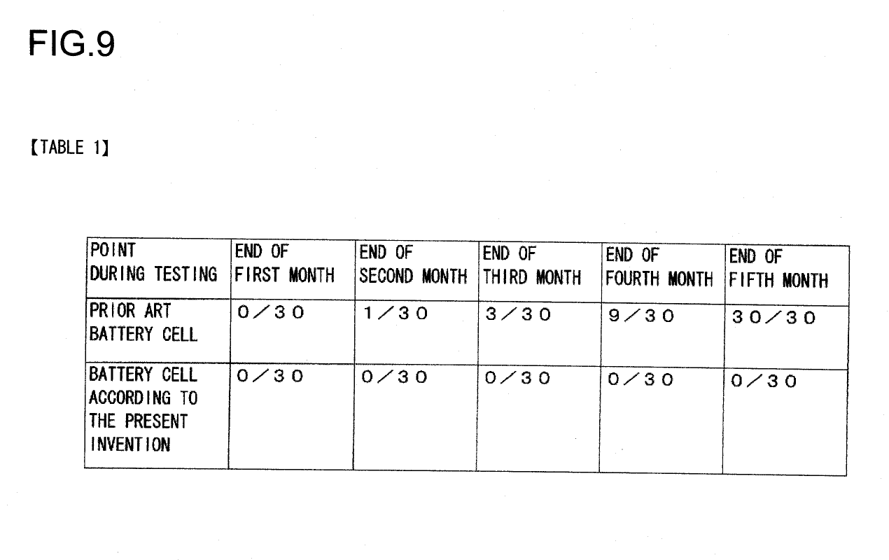

In FIG. 9, the results of leakage resistance testing of non-aqueous electrolyte battery cells that were sealed with the above described sealing processing are shown as compared with prior art examples. In this leakage resistance testing, thirty samples of the present invention and thirty samples of the prior art are tested in cycles for five months at a temperature between −40° C. and +90° C. and at a relative humidity of 80%.

In the case of the prior art example, the number of leaks after 2 months was 1, after 3 months was 3, after 4 months was 9, and after 5 months all of the samples were leaking. On the other hand, with this embodiment of the present invention, after five months had elapsed, none of the samples was leaking to the slightest degree. This confirms the quality and the stability of the sealing performance obtained according to the present invention.

When after this testing the battery cells of the prior art example and the battery cells according to this embodiment were opened up and inspected, corrosion oxidization (i.e. rust) was seen on the inner peripheral edges 62a of the open end portions of all of these battery cells. It is considered that this was because it was quite easy for abraded and flawed portions to be created upon the inner peripheral edges 62a of the folded over portions 62 during the swaging process, and corrosion took place at the sites of these flaws when the cells were subjected to the severe temperature cycling at the high relative humidity of 80%.

However it is considered that while, with the non-aqueous electrolyte type battery cells according to the present invention in which, as previously described, the sealing against ingress of water was performed by swaging the insulating gasket 43 at the open end portion 60a of the battery cell container 60 (i.e. at the folded over portion 62), and the sealing performance is determined by most compressed point the insulating gasket 43. In the prior art examples, the point of maximum compression was established at the inner peripheral edge 62a of the folded over portion 62, and accordingly corrosion oxidization at this location was easily able to break the seal, so that leakage of fluid occurred.

On the other hand, in this embodiment, since the region 61B that is the second point of compression is disposed more towards the internal space within the battery cell container 60, and the region 61A that is the first compression point is provided between this second compression point and the folded over inner peripheral edge portion 62a, and moreover a perfluorocarbon type fluororesin is employed for manufacturing the insulating gasket 43, accordingly the points of compression of the gasket 43 may be set to any desired positions and to any desired compression ratios. Therefore, even if the internal peripheral edge of the open end of the casing portion is damaged or destroyed by corrosion, it is considered that no influence will be exerted upon the sealing points, and that no electrolyte leakage will take place.

Therefore, the present invention is not to be considered as being limited to the embodiment described above, in which 2 sealing points 61A and 61B are provided. Accordingly, to explain with reference to the drawings, any non-aqueous electrolyte cylindrical battery cell that includes a generating unit 20, a battery cell container 60 that contains the generating unit 20, and a sealing lid 50, disposed in an open end portion 60a of the battery cell container 60, and that seals the battery cell container 60 via an insulating gasket 43, and in which one sealing point of the insulating gasket 43 is established at a region 61A that is spaced by a predetermined distance in the radially outward direction of the battery cell from the inner peripheral edge 62a of the folded over portion 62 that is formed at the open end portion 60a of the battery cell container 60, is to be considered as being an embodiment within the scope of the present invention.

Even if, according to this definition of the present invention, a single such sealing point is provided, it is clear that it is possible to enhance the durability of the battery cell by establishing this sealing point at a position on the external periphery of the battery cell that is towards the interior of the battery cell from the inner peripheral edge 62a of the battery cell container folded over portion 62, where there is the highest possibility of corrosion.

Furthermore, any non-aqueous electrolyte cylindrical battery cell that includes a generating unit 20, a battery cell container 60 that contains the generating unit 20, and a sealing lid 50, disposed in an open end portion 60a of the battery cell container 60, and that seals the battery cell container 60 via an insulating gasket 43, and in which compression points where the compression ratio of the insulating gasket 43 is high are established upon the upper and lower surfaces of the peripheral portion 50F of the sealing lid 50, is also to be considered as being an embodiment within the scope of the present invention. In this case, as in the above definition of the present invention, while it is desirable to ensure that the gasket compression ratio at the compression point that is positioned more towards the interior of the battery cell is the higher, so that the compression ratio at the first compression point is higher than the second compression ratio, it would also be acceptable for these first and second compression ratios to be equal to one another.

It would also be acceptable to establish sealing points at three or more locations.

The embodiments described above may be used individually or in any combination, since these embodiments may each independently be effected or may be synergistically effected when used in any combination. In addition, as long as the aspects characterizing the present invention are not impaired, the present invention is not limited to the embodiments described above.

1. A cylindrical battery cell containing a non-aqueous electrolyte, comprising:
a generating unit;
a battery cell container that contains the generating unit; and
a sealing lid, disposed in an open end portion of the battery cell container, and that seals the battery cell container via an insulating gasket;
wherein a sealing point of the insulating gasket is established at a region that is spaced by a predetermined distance in radially outward direction of the cylindrical battery cell from an inner peripheral edge of a folded over portion that is formed at the open end portion of the cylindrical battery cell container.

2. A cylindrical battery cell containing a non-aqueous electrolyte, comprising:
a generating unit;
a battery cell container that contains the generating unit; and
a sealing lid, disposed in an open end portion of the battery cell container, and that seals the battery cell container via an insulating gasket;
wherein the sealing lid is fixed by swaging at the open end portion of the battery cell container so that upper and lower surfaces of its peripheral portion are sandwiched by the insulating gasket, and so that sealing points are established upon the insulating gasket where it contacts the upper and lower surfaces of the peripheral portion of the sealing lid.

3. A cylindrical battery cell containing a non-aqueous electrolyte according to claim 2, wherein the respective thickness dimensions Ha and Hb of the insulating gasket at the sealing points at the upper and lower surfaces of the peripheral portion after processing satisfy Ha>Hb.

4. A cylindrical battery cell containing a non-aqueous electrolyte according to claim 2, wherein:
an annular swaged space is defined at the open end portion of the battery cell container; and
the upper and lower surfaces of the peripheral portion of the sealing lid are sandwiched within a inner surface of the annular swaged space, with the interposition of the insulating gasket.

5. A cylindrical battery cell containing a non-aqueous electrolyte according to claim 4, wherein the annular swaged space is a space that is sandwiched between a protruding portion that is formed by concaving inwards the outer peripheral surface of the open end portion of the battery cell container, and a folded over portion that is formed by folding over the open end portion of the battery cell container towards interior of the battery cell, and the folded over portion is formed as a sloping surface that is parallel to a plane orthogonal to the axis of the battery cell, or whose angle of inclination downwards towards an axis of the battery cell is less than 5°.

6. A cylindrical battery cell containing a non-aqueous electrolyte according to claim 1, wherein the insulating gasket is made from a perfluorocarbon type fluororesin.

7. A cylindrical battery cell containing a non-aqueous electrolyte according to claim 2, wherein the insulating gasket is made from a perfluorocarbon type fluororesin.
